(19) United States
(12) Patent Application Publication
(10) Pub. No.: US 2018/0113720 A1
(43) Pub. Date: Apr. 26, 2018

(54) DYNAMICALLY RECONFIGURING A BROWSER BAR AND SECURE APPLICATION INSTALLATION

(71) Applicant: Sivakumar Yeddnapuddi, Van Buren Township, MI (US)

(72) Inventor: Sivakumar Yeddnapuddi, Van Buren Township, MI (US)

(21) Appl. No.: 15/794,711

(22) Filed: Oct. 26, 2017

Related U.S. Application Data
(60) Provisional application No. 62/413,412, filed on Oct. 26, 2016.

(51) Int. Cl. G06F 9/44; H04W 4/04; G06F 3/0484; G01C 21/36

(52) U.S. Cl. CPC G06F 9/4443; G01C 21/3664; G06F 3/0484; H04W 4/046

(57) ABSTRACT

Disclosed herein are devices, methods and systems for implementing a reconfigurable browser bar. The aspects disclosed herein are related to the order of the applications presented to a view via a vehicle-based human machine interface (HMI), as well as installation/security associated with implementing said applications in the vehicle-based HMI.

### CROSS-REFERENCE TO RELATED APPLICATIONS

This patent application claims priority to U.S. Provisional Patent Application No. 62/413,412, filed Oct. 26, 2016, entitled “DYNAMICALLY RECONFIGURING A BROWSER BAR AND SECURE APPLICATION INSTALLATION,” now pending. This patent application contains the entire Detailed Description of U.S. Provisional Patent Application No. 62/413,412.

### BACKGROUND

Vehicles and other modes of transportation are being integrated with electronics configured to allow interaction from a driver, passenger or operator of the vehicle to interact with certain vehicle controls systems, such as advanced driver assistance system (ADAS), entertainment, climate control, and the like. A driver, passenger or operator may refer to any person interacting with the vehicle, either within or remotely with said vehicle (all three will be referred to as “operator”).

Often times, these electronic components are provided with a human-machine interface (HMI) capable of displaying/projecting/outputting information to a driver, passenger or operator. The HMI includes a kernel, with at least a first operating system (secured), and a second operating system (open to third-party application development), and allows interaction with the operator through the HMI system. The second operating system, may be one of many open systems known, such as browser based operating systems employed as middleware loaded onto a secure operating system (such as the secure operating system mentioned above).

Both the first operating system and the second operating system are configured to receive applications (or the applications may be pre-loaded), which are modules added to the operating system, and stored either locally or remotely (i.e., in cloud storage), and configured to execute said applications. The applications may be executed by either a deliberate or active instigation from the operator, or through a trigger pre-associated with the application (i.e., at a predetermined time, based on a signal received from another vehicle control system, or a third-party not including the operator).

As vehicle control units and HMI systems become more prevalent in the vehicle context, the need to provide an increased or improved user experience also is demanded. An improved HMI not only improves an operator's enjoyment of the vehicle, but may also improve overall safety and awareness of the operator's interaction with the environment.

As the vehicle becomes more integrated with electronic componentry, the vehicle also assumes risks associated with malicious data, from either applications with inadvertent problems or from purposeful attacks to the vehicle and the vehicle's sub components.

### SUMMARY

The following description relates to systems, methods, and applications for implementing a reconfigurable browser bar, and a vehicle-based human machine interface (HMI) implementing the same. Exemplary embodiments may also be directed to any of the system, the method, or an application disclosed herein.

Additional features of the invention will be set forth in the description which follows, and in part will be apparent from the description, or may be learned by practice of the invention.

Disclosed herein are devices, methods and systems for implementing a reconfigurable browser bar. The aspects disclosed herein are related to the order of the applications presented to a view via a vehicle-based human machine interface (HMI), as well as installation/security associated with implementing said applications in the vehicle-based HMI.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The detailed description refers to the following drawings, in which like numerals refer to like items, and in which:

FIG. 1 illustrates an exemplary method for reconfiguring a browser bar according to the aspects disclosed herein;

FIG. 2 illustrates a transformation of a vehicle-based human machine interface (HMI) implementing a reconfigurable browser bar as described herein;

FIG. 3 illustrates a method for implementing a vehicle-based application installation system with a manifest; and

FIG. 4 illustrates a system according to the method described in FIG. 3.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Providing applications to an operator of a vehicle improves the operator's enjoyment of the vehicle, while potentially improving the operator's safety and However, as the number of applications increases, providing and presenting said applications in an organized and efficient manner becomes paramount to the overall vehicle experience.

Additionally, as the vehicle, vehicle's computer(s), and various sub-components are exposed to various applications (either from a third-party, the vehicle manufacturer, a component/sub-component manufacturer), the vehicle, the vehicle's computer(s), and various sub-components become exposed to either inoperable or poorly working applications and malicious attacks.

Disclosed herein are methods and systems for addressing the above-listed issues. Specifically, disclosed herein are methods and system for dynamically providing a reconfigurable browser bar to display applications based on a vehicular context. Additionally, disclosed herein are methods and system for ensuring a secure installation of applications for a vehicle computer system.

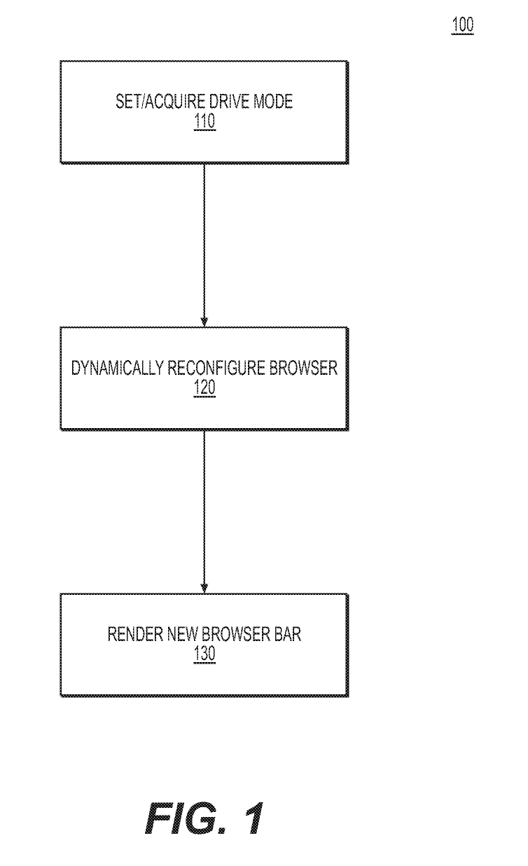

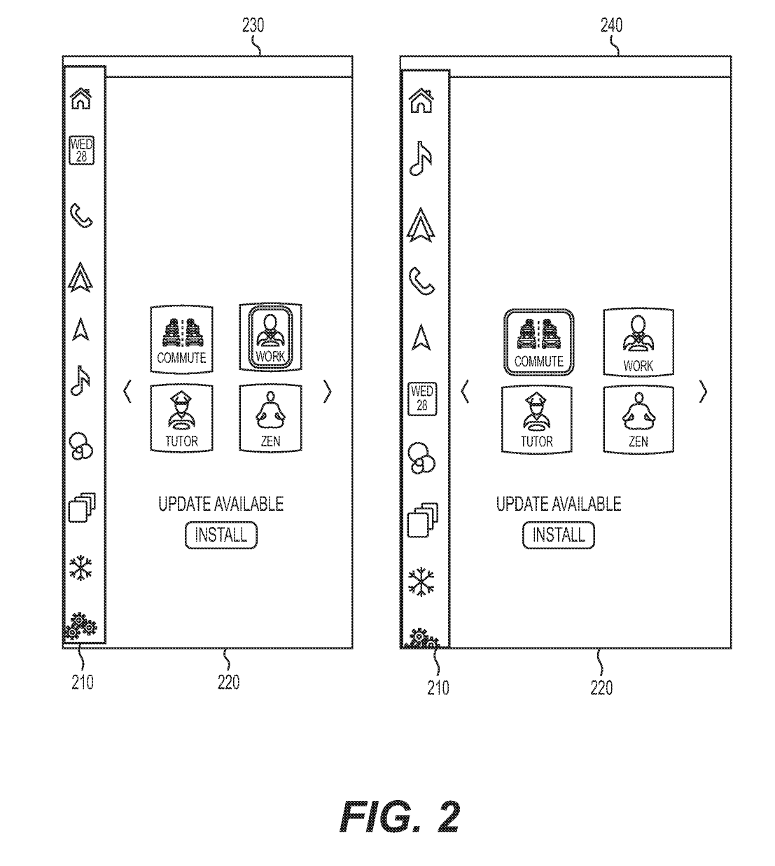

FIG. 1 illustrates a method 100 for dynamically reconfiguring a graphical user interface (GUI) 200. FIG. 2 illustrates an example of the GUI 200.

As shown in FIG. 2, the GUI 200 represents a browser-based display. The browser shown in FIG. 2 is configured to present applications associated with a vehicular operation. The GUI 200 is any sort of user interface (UI associated with a HMI system installed in a vehicle. The GUI includes a browser bar 210 and a view area 220. The browser bar 210 displays a plurality of icons, with each icon representing an application associated with or stored on the vehicle. In certain cases, the application may be locally stored, while in other cases, some or all of the applications may be accessible through a network connection, such as cloud storage.

In FIG. 2, a first screen 230 is presented. Also shown is a second screen 240. The transition from the first screen 230 to the second screen 240 (and vice-versa), will be explained in greater detail with the explanation of method 100.

As shown in FIG. 1, in operation 110, a drive mode is ascertained. A drive mode is associated with a specific type of drive an operator may be associated. In operation 110, various alternate embodiments may be employed to ascertain the drive mode.

In one example, and as shown in both the first screen and the second screen, the drive mode may be manually selected through an input. As shown, various icons are presented in the view area 220, with respective icons being selected. The selected icon may refer to the drive mode associated with operation 110.

In another example, the drive mode is acquired through an automatic process. For example, information from a source, such as another app, may indicate that one of the drive modes should be selected (for example, a calendar appointment indicating that the operator is travelling from home to work). Alternatively, the automatic process may be configured to detect a drive mode based on a detected route being travelled (i.e. from the operator's home to work).

In another example, the drive mode may be retrieved through the following manner. For example, the browser bar may be reconfigured absent a drive mode being acquired, and instead upon vehicle start-up. In such a case, the dynamic nature of the browser bar may be impacted by other influences such as frequency of use, operator identifiers (where biometric features of the operator such as voice analysis, weight, height, facial or eye recognition from sensors in the vehicle), devices contacted to the vehicle (phones, pads, watches, wearable technology, geographical location, driving route, time of day, road condition, weather, alerts, learned activity (for example, if the operator stops for coffee multiple and periodically, or finishes activity at a predetermined interval), into adaptive learning algorithms to modify the browsers configuration, and provide access to information and media personalized to the operator, and based on the driving conditions of the vehicle.

Once a drive mode is acquired, in operation 120, the browser bar 210 is dynamically reconfigured. As such, the order and the apps shown in the browser bar 210 may be correlated to predefined data stored either in a vehicle contained data store, or on another network source (such as cloud storage).

In another option, the operator may pre-select or prioritize certain apps on the browser and the information to be displayed by the HMI. A dynamic learning system may be configured to use the operator's preferences in to allow the operator to create self-stitching of apps and information to customize the driving experience and the information delivered to the operator.

Some of the examples above employ a deliberate action by an operator to either set or select the drive mode, and or apps. The aspects disclosed herein also may be integrated with adaptive learning algorithms, with the learning algorithms being integrated into either selecting the configuration of browser icons based on a driving pattern or activity associated with interacting with a vehicle, or selecting a combination of icons to render on the browser.

In operation 130, the reconfigured browser bar 210 is rendered. As shown in the first screen 230, the browser bar 210 corresponds to a drive mode associated with a commute. As such, the order and availability of apps may correspond to this drive mode.

In the second screen 240, the drive mode is associated with work, and as such, the browser bar 210's display may correspond to this drive mode.

The actual order and availability of apps may be set by an operator, downloaded from a predefined ordering, or automatically determined based on frequency of use while in a certain drive mode. Additionally, when an application is installed (as explained in detail below), the applications installation may determine an insertion of an application in a specific browser bar based on predefined information, or predictive analytics.

The above-noted descriptions pre-correlate the display of applications based on a selected drive mode. In another example, or alternate embodiment, the order or display of applications may be based on a pre-selected setting (i.e. cached setting), or history of applications chosen, as correlated to a traversed route or interaction with the vehicle. Also, the aspects disclosed herein may correlated the selection of applications based on previous settings or selected applications based on actions previously taken based on triggers associated with various other applications (for example, defined elements associated with vehicle applications, such as calendar applications, phone applications, navigation applications, and the like).

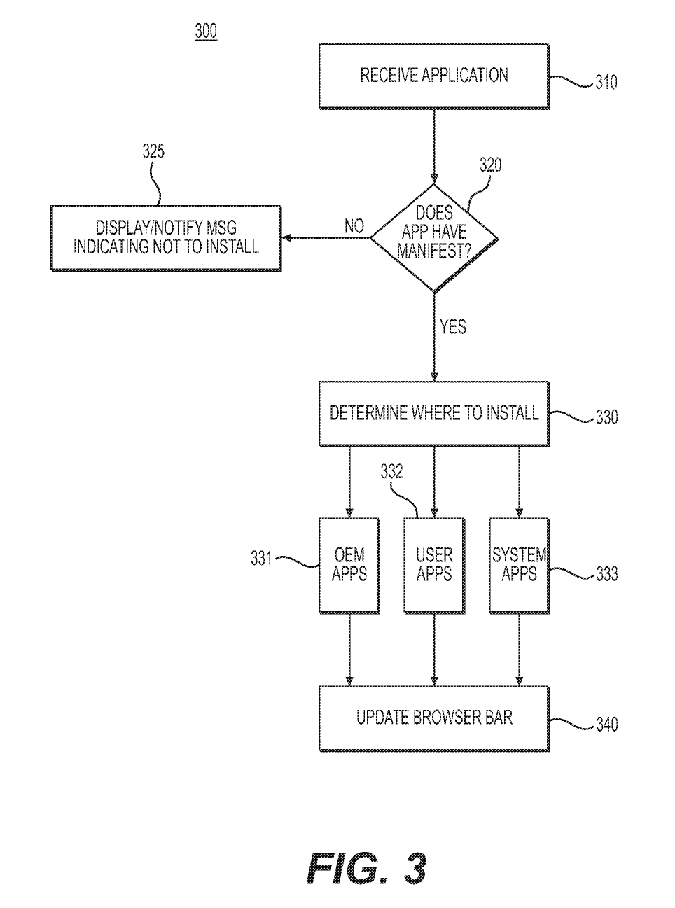

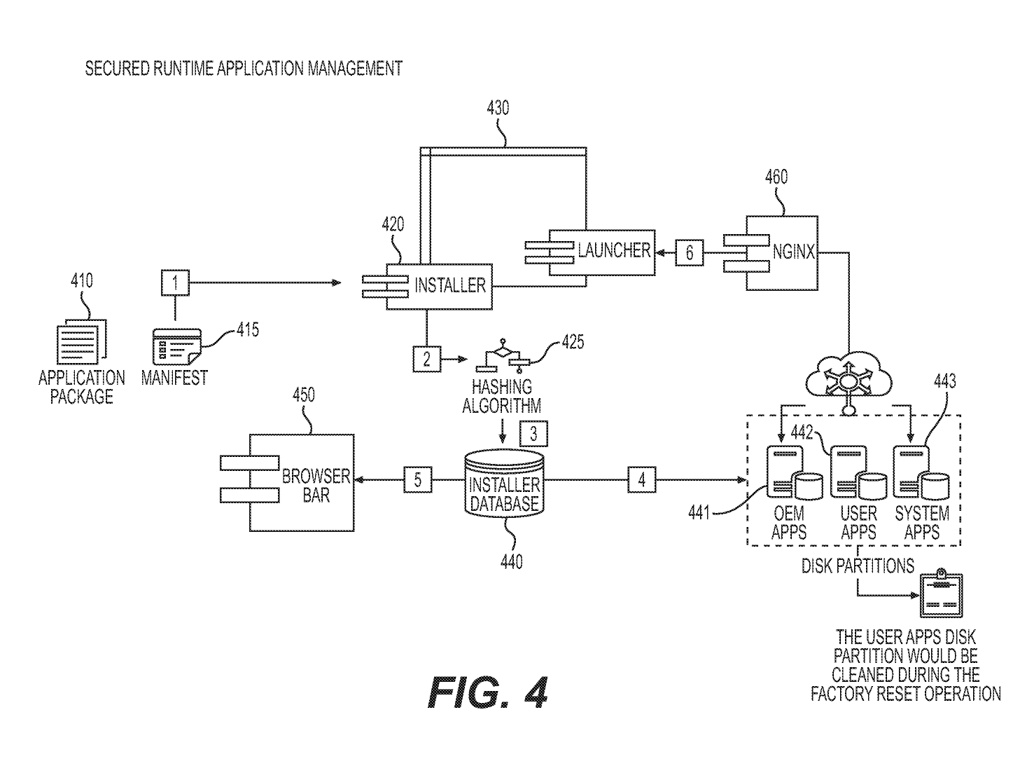

FIG. 3 illustrates a method 300 for installing applications. FIG. 4 illustrates a flow-chart 400 explaining method 300. As shown in FIG. 4, a browser bar 450 is also included. The browser bar 450 may optionally be configured to operate with the aspects described above with method 100.

In operation 310, an application 410 is received by an installer 420. The application 410 may be developed with a software development kit (SDK) incorporating a vehicle simulator, as disclosed in a related application. The application 410 may be provided with a manifest 415.

The manifest 415 includes instructions as to where the application 410 is to be installed on. Further, the manifest 415 also includes any authentication, securities, or other encryption techniques, thereby authorizing the installation of the application into various portions of the vehicle's computing system.

The installer 420 is stored and saved on an operating system 430. The operating system 430 may be a multi-level operating system according to the referenced applications and references disclosed herein.

In operation 320, after the application 410 is received by an installer 420, a determination is made as to whether a manifest is included or if the manifest allows authorization to install the application 410. If the manifest 415 included is proper, the method 300 proceeds to operation 330. If the manifest 415 is not proper (i.e. incapable of providing an established authentication information or indicate compatibility with vehicle the operation system 430 is installed on), the method 300 proceeds to operation 325, where a display/notification message is provided/transmitted indicating that the application 410 is not to be installed.

In operation 330, a determination as to which partition the application 410 should be installed-on is made. As shown in FIG. 4, an installer database 440 is provided with three exemplary partitions, OEM 441, user 442, and system 443. As such, depending on a hashing algorithm 425, a determination of the proper partition to install is made in operation 330.

In one of operations 331-333, and after the proper partition is chosen (e.g, 441-443), the chosen partition is mounted (placed into read/write mode), and the application 410 is installed on the chosen/determined partition. After the installation is complete, the partition that was mounted, is then unmounted (placed in read mode). As such, the various partitions associated with the storage of vehicular applications are isolated from being written to during the operation and execution of the applications by the operating system(s) 430, via an application loader 460.

In operation 340, the browser bar 450 may be automatically updated according to the installation/updating of the application 410. For example, the operating system 430 may be provided with a predictive analytic system to determine that the application 410 is to be incorporated into the browser bar 450's GUI based on a predetermined correlation to one of the drive modes (as explained above with regards to FIGS. 1 and 2.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A system for implementing a reconfigurable browser bar displayed via a vehicle-based human machine interface (HMI), comprising:
a data store comprising a non-transitory computer readable medium storing a program of instructions for the providing;
a processor that executes the program of instructions, the instruction comprising the following steps:
obtaining a mode associated with a vehicle operation;
based on the obtained mode, dynamically reconfiguring an order of the browser bar, wherein the browser bar sequentially displays at least two or more graphical user interface (GUI) elements each associated with a specific application; and
rendering the dynamically reconfigured browser bar via the vehicle-based HMI.

2. The system according to claim 1, wherein the obtaining is defined by receiving a selection via a mode screen.

3. The system according to claim 1, wherein the obtaining is defined by automatically detecting a route of a vehicle associated with the vehicle-based HMI, and based on the route, determining the mode based on predefined information.

4. The system according to claim 1, wherein the mode is obtained by retrieving information from an application executed on the vehicle-based HMI.

5. The system according to claim 4, wherein the retrieved information is a present time, and based on time related information, employing a predefined association of the present time with a specific mode.

6. The system according to claim 4, wherein the information is related to a meeting, and employing a predefined association of the meeting with a specific mode.

7. The system according to claim 1, wherein an order associated with the route is based on prior application selections associated with the route during previous trips taken by the vehicle.

8. The system according to claim 1, wherein the mode is associated with a biometric sensor reading of a driver.

9. A system for allowing selective installation for a vehicle-based human machine interface (HMI), comprising:
a data store comprising a non-transitory computer readable medium storing a program of instructions for the providing;
a processor that executes the program of instructions, the instruction comprising the following steps:
receiving an application to be installed on the vehicle-based HMI;
receiving a manifest associated with the application; and
installing the application in a specific database based on the manifest, the specific database being associated with permissions associated with access to vehicle-based controls.

10. The system according to claim 9, wherein the specific database consists of one of the following: original equipment manufacturing applications, user applications, and system applications.

11. The system according to claim 9, further comprising a reconfigurable browser bar, and the manifest being defined to include a position of the application on the reconfigurable browser bar.

12. The system according to claim 11, wherein the processor is further configured to:
obtain a mode associated with a vehicle operation;
based on the obtained mode, dynamically reconfigure an order of the reconfigurable browser bar, wherein the browser bar sequentially displays at least two or more graphical user interface (GUI) elements each associated with a specific application; and
render the dynamically reconfigured browser bar via the vehicle-based HMI.
